(19) United States
(12) Patent Application Publication
(10) Pub. No.: US 2026/0304100 A1
(43) Pub. Date: Oct. 1, 2026

(54) LOCATION-BASED CONFIGURATION OF WIRELESS DEVICES

(71) Applicant: Charter Communications Operating, LLC, St. Louis, MO (US)

(72) Inventors: Vinayak Kumar Thotton Veetil, Parker, CO (US); Peter H. Palli, Snellville, GA (US)

(21) Appl. No.: 19/089,699

(22) Filed: Mar. 25, 2025

(51) Int. Cl. H04W 8/22

(52) U.S. Cl. CPC H04W 8/22

(57) ABSTRACT

A communication management resource receives first input associated with user equipment. The user equipment is configured with first configuration settings to communicate with a first wireless network. Based on the first input, the communication management resource detects a trigger condition associated with the user equipment. The trigger condition may be any suitable one or more events such as including detection that the user equipment resides in a proximity of a second wireless network. In response to detecting the condition, the communication management resource configures the user equipment to communicate with the second wireless network. Configuring of the user equipment may include the communication management resource initiating transmission of the second configuration settings to the user equipment.

### BACKGROUND

A subscriber identity module or subscriber identification module (SIM), also known a SIM card, is an integrated circuit that is used to securely store information such as the international mobile subscriber identity (IMSI) telephony number and its related key information. Such information is used to identify and authenticate subscribers on mobile communication devices when they use a respective wireless network.

A conventional SIM circuit is part of the function of a Universal Integrated Circuit Card (UICC) physical smart card, which is usually fabricated from a plastic material embedded with contacts and a corresponding semiconductor circuit. Conventional SIM information in a SIM card is transferable between different mobile devices.

A conventional SIM card stores subscriber information such as a unique serial number (ICCID), international mobile subscriber identity (IMSI) number, security authentication and ciphering information, temporary information related to the local network, a list of the services the user has access to, and two passwords such as a personal identification number (PIN) for ordinary use, and a personal unblocking key (PUK) for PIN unlocking.

Newer SIM technology supports so-called embedded SIM information. For example, a conventional embedded-SIM (eSIM) or embedded universal integrated circuit card (eUICC) is a form of programmable SIM card that is embedded directly into a mobile communication device.

After being configured with respective SIM information, a mobile communication device is unable to use a corresponding conventional wireless network to communicate with a remote network.

As an example, assume that a mobile communication device establishes a respective wireless communication link with a first wireless base station. The first wireless base station is coupled to a so-called backhaul that provides connectivity between the first wireless base station and a remote network such as the Internet. Via communications over the respective wireless communication link, and corresponding backhaul, the mobile communication device is able to send/receive data over the Internet.

### BRIEF DESCRIPTION OF EXAMPLES

Example configurations as discussed herein support novel implementation of configuring (such as dynamic provisioning) one or more mobile communication devices (a.k.a., multiple instances of user equipment) with network access settings depending upon one or more triggering events such as entry or movement of a respective mobile communication device into a location or geographical region, event, time duration of being in a geographical region, usage of wireless services by the respective mobile communication device, service requested by the mobile communication device, device type associated with the respective mobile communication device, device trigger, network trigger, etc.

In one example, a mobile communication device communicates information such as location, usage, device type, request a specific service, etc., to a communication management resource. In response to the detected one or more trigger event, the communication management resource can be configured to provision the mobile communication device with new SIM information enabling the respective mobile communication device to use a corresponding wireless network.

More specifically, a communication management resource as described herein receives first input associated with user equipment, where the user equipment is configured with first configuration settings to communicate with a first wireless network. Based on the first input, communication management resource detects a condition in which the user equipment resides in a region of wireless coverage provided by a second wireless network. In response detecting the condition, the communication management hardware configures the user equipment with second configuration settings to communicate with the second wireless network.

In one example, the first configuration settings support first wireless connectivity and conveyance of corresponding first communications between the user equipment and the first wireless network prior to detecting the condition of being present in a geographical region. The communication management resource can be configured to transmit the second configuration settings over the first wireless network to the user equipment.

It is further noted that the first input may indicate a location of the user equipment in a network environment. The detected condition may be detected presence of the user equipment in the region of wireless coverage provided by the second wireless network, where the detected presence is determined based on the user equipment using the first wireless network.

In further examples, configuration of the user equipment with the second configuration settings may include the communication management hardware transmitting the second configuration settings over the first wireless network to the user equipment. The first wireless connectivity between the user equipment and the first wireless network (as provided by a first wireless network service provider) can be configured to support both voice communications and non-voice communication; the second wireless connectivity between the user equipment and the second wireless network (as provided by a second wireless network service provider) supports may only non-voice communications.

In still further examples, the first input received by the communication management resource can be configured to indicate or include location information indicating at least one location in which the user equipment is operated to wirelessly connected to a third first wireless network. It is further noted that the user equipment may be configured to communicate with the second wireless network via the second configuration settings in response to detecting presence of the user equipment in a particular geographical region for greater than a threshold level of time.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), or non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a computer readable storage hardware or medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes a computer readable storage medium and/or system having instructions stored thereon to facilitate better use of available wireless resources in a network environment. The instructions, when executed by computer processor hardware, cause the computer processor hardware (such as one or more co-located or disparately processor devices or hardware) to: receive first input associated with user equipment, the user equipment configured with first configuration settings to communicate with a first wireless network; based on the first input, detect a condition in which the user equipment resides in a proximity of a second wireless network; and in response to detecting the condition, configure the user equipment to communicate with the second wireless network.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of network access. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless network environment including multiple different wireless networks providing a respective mobile communication device access to a remote network as discussed herein.

FIG. 2 is an example diagram illustrating back-office infrastructure supporting management of a mobile communication device accessing a remote network through multiple different wireless networks supported by multiple different wireless network service providers as discussed herein.

FIG. 3 is an example diagram illustrating a network environment supporting provisioning of configuration settings to a mobile communication device in response to one or more trigger events as discussed herein.

FIG. 4 is an example flow chart illustrating implementation of a management algorithm at a mobile communication device supporting dynamic provisioning of wireless connectivity configuration settings based on one or more trigger events as discussed herein.

FIG. 5 is an example flow chart illustrating implementation of a management algorithm at a server resource supporting dynamic provisioning of wireless connectivity configuration settings based on one or more trigger events as discussed herein.

FIG. 6 is an example diagram illustrating tracking of events associated with a communication device wirelessly connected to a first wireless network and provisioning of wireless connectivity configuration settings associated with a second wireless network as discussed herein.

FIG. 7 is an example diagram illustrating implementation of the provisioned wireless connectivity configuration settings by a communication device to access a remote network through the second wireless network as discussed herein.

FIG. 8 is an example diagram illustrating tracking of events associated with a communication device wirelessly connected to a third wireless network and provisioning of wireless connectivity configuration settings associated with a second wireless network as discussed herein.

FIG. 9 is an example diagram illustrating implementation of the provisioned wireless connectivity configuration settings by the communication device to access a remote network through the second wireless network as discussed herein.

FIG. 10 is an example diagram illustrating example computer architecture operable to execute one or more operations as discussed herein.

FIG. 11 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A communication management resource receives first input associated with user equipment. The user equipment is configured with first configuration settings to communicate with a first wireless network. Based on the first input, the communication management resource detects a trigger condition associated with the user equipment. The trigger condition may be any suitable one or more events such as including detection that the user equipment resides in a proximity of a second wireless network. In response to detecting the condition, the communication management resource configures the user equipment to communicate with the second wireless network. Configuring of the user equipment may include the communication management resource initiating transmission of the second configuration settings to the user equipment.

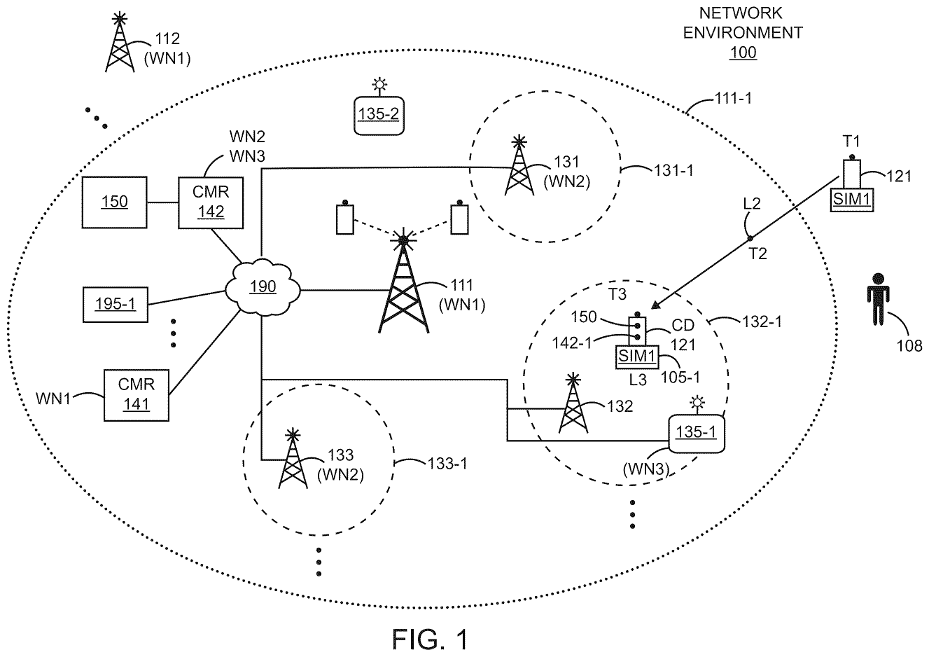

Now, more specifically, with reference to the drawings, FIG. 1 is an example diagram illustrating a wireless network environment and corresponding multiple different wireless networks providing a respective mobile communication device access to a remote network as discussed herein.

As shown in FIG. 1, the network environment 100 includes multiple wireless networks such as wireless network WN1, wireless network WN2, wireless network WN3, etc., supporting access to the remote network 190 and corresponding one or more server resources 195-1.

Network environment 100 further includes one or more management resources such as communication management resource 141, communication management resource 142, etc., to manage wireless connectivity associated with the respective wireless base stations, wireless access points, etc.

The communication management resource 141 may be implemented and reside at a single location or may be implemented as distributed functionality residing at multiple different locations; the communication management resource 142 may be implemented and reside at a single location or may be implemented as distributed functionality residing at multiple different locations; and so on.

Any of the resources as discussed herein can be configured as hardware, software, or a combination of hardware and software. More specifically, the communication management resource 141 can be implemented as communication management hardware, communication management software, or a combination of communication management hardware and communication management software; the communication management resource 142 can be implemented as communication management hardware, communication management software, or a combination of communication management hardware and communication management software; the mobile communication device 121 and corresponding functionality may be implemented as mobile communication hardware, mobile communication software, or a combination of mobile communication hardware and mobile communication software; and so on.

Assume in this example that the wireless network WN1 (such as a 5G network) is operated by a first wireless network service provider (WNSP1) and that the wireless network WN2 and wireless network WN3 are operated by a second wireless network service provider (WNSP2). In one example, the first wireless network service provider is a so-called MNO, or Mobile Network Operator.

As further shown, the first wireless network WN1 can be configured to include any number of wireless base stations supporting wireless connectivity to the remote network 190. For example, wireless network WN1 can be configured to include wireless base station 111, wireless base station 112, etc.

Yet further, the second wireless network WN2 can be configured to include any number of wireless base stations supporting wireless connectivity to the remote network 190. For example, wireless network WN2 can be configured to include wireless base station 131, wireless base station 132, wireless base station 133, etc.

In one example, the second wireless network WN2 supports wireless communications using one or more wireless channels allocated from a so-called CBRS (Citizen Band Radio Service) band. The allocated wireless channels used by the second wireless network WN2 may be revoked at any time based on higher priority usage of those allocated wireless channels by a so-called incumbent entity.

Still further, the third wireless network WN3 can be configured to include any number of wireless access points such as wireless access point 135-1, wireless access point 135-2, etc.

It is noted that the different wireless base stations and wireless access points may each provide a different sized region of wireless coverage. For example, as shown in FIG. 1, the wireless base stations 111, 112, etc., can be configured to support a large region of wireless coverage; the wireless base stations 131, 132, etc., can be configured to support a medium or small region of wireless coverage; the wireless access points 135-1, 135-2, etc., can be configured to support a pico region of wireless coverage.

Each of the different wireless networks can be configured to support wireless communications in accordance with any suitable wireless communication protocol. In one example, the first wireless network WN1 and the second wireless network WN2 support cellular communications while the third wireless network WN3 supports Wi-Fi™ communications (such as listen before talk communications).

The communication management resource 141 can be configured to manage the first wireless network WN1 and corresponding wireless connectivity supported by the wireless base stations 111, 112, etc.

The communication management resource 142 can be configured to manage the first wireless network WN2 and corresponding wireless connectivity supported by the wireless base stations 131, 132, etc.

In this example, the communication device 121 is configured with first configuration settings 105-1 (such as first Subscriber Identity Module information or SIM1), which support wireless communications with any of the wireless base stations 111, 112, etc., (first wireless network WN1), which are controlled and operated by the first wireless network service provider.

As further shown in this illustrative example, wireless base station 111 supports the region of wireless coverage 111-1. In such an instance, the communication devices subscribing to the wireless services provided by the first wireless network service provider (wireless network WN1) and present inside the region of wireless coverage are able to receive wireless communications from the wireless base station 111 as well as transmit wireless communications to the wireless base station 111.

There are multiple wireless base stations (131, 132, 133, etc.) associated with the second wireless network WN2 that reside within the region of wireless coverage 111-1. Each of the wireless base stations 131, 132, 133, etc., support their own region of wireless coverage.

For example, the wireless base station 131 in wireless network WN2 supports the region of wireless coverage 131-1. In such an instance, the communication devices subscribing to the wireless services provided by the second wireless network service provider and present inside the region of wireless coverage 131-1 are able to receive wireless communications from the wireless base station 131 as well as transmit wireless communications to the wireless base station 131.

The wireless base station 132 in wireless network WN2 supports the region of wireless coverage 132-1. In such an instance, the communication devices subscribing to the wireless services provided by the second wireless network service provider and present inside the region of wireless coverage 132-1 are able to receive wireless communications from the wireless base station 132 as well as transmit wireless communications to the wireless base station 132.

The wireless base station 133 in wireless network WN2 supports the region of wireless coverage 133-1. In such an instance, the communication devices subscribing to the wireless services provided by the second wireless network service provider and present inside the region of wireless coverage 133-1 are able to receive wireless communications from the wireless base station 133 as well as transmit wireless communications to the wireless base station 133.

In this example, the communication device 121 is only configured with first configuration settings 105-1 (such as first Subscriber Identity Module information), which support wireless communications with any of the wireless base stations 111, 112, etc., in the first wireless network WN1.

As further shown in this example, the communication device 121 (a.k.a., user equipment) roams about the network environment 100. For example, at time T1, the mobile communication device 121 resides outside of the region of wireless coverage 111-1. At time T2, the mobile communication device 121 operated by a respective user resides inside the region of wireless coverage 111-1. At time T3, the mobile communication device 121 resides in both the region of wireless coverage 111-1 and the region of wireless coverage 132-1. However, because the mobile communication device 121 is configured only with the configuration settings 105-1, the mobile communication device is only able to establish wireless connectivity with the remote network 190 through the wireless base station 111 of the first wireless network WN1.

It is further noted that the user 108 operating the mobile communication device 121 may subscribe to wireless services provided by the second wireless network service provider operating the second wireless network WN2 and third wireless network WN3. As further discussed herein, in certain circumstances it is desirable to configure the mobile communication device 121 to support wireless communications with the second wireless network WN2 and/or the third wireless network WN3 such as during conditions in which the mobile communication device 121 resides within a particular geographical region for greater than a threshold amount of time. Additional details of such examples are presented below.

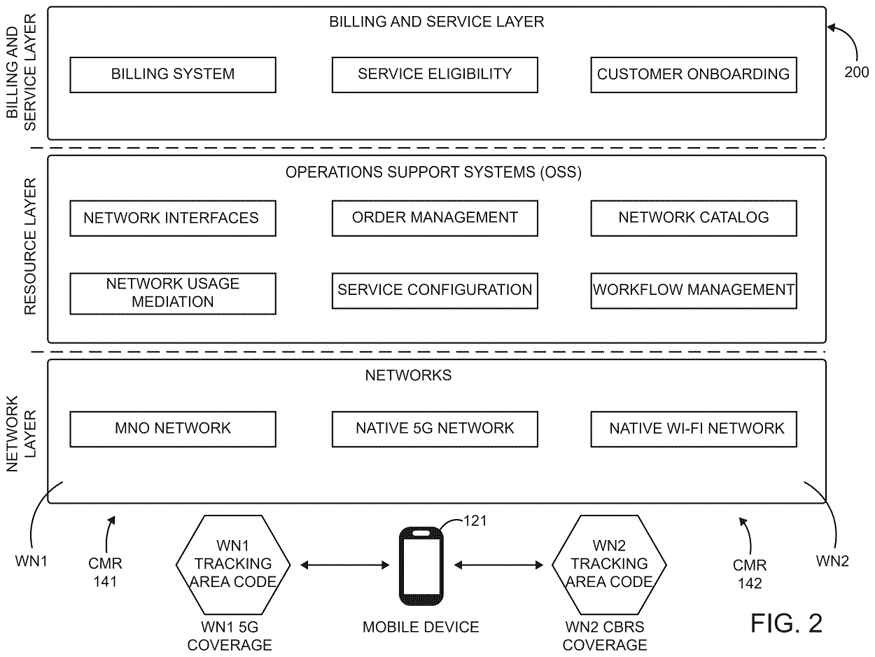

FIG. 2 is an example diagram illustrating back-office infrastructure supporting management of a mobile communication device accessing a remote network through multiple different wireless networks supported by multiple different wireless network service providers as discussed herein.

An example method of managing wireless connectivity associated with the mobile communication device 121 as discussed herein may be performed by a native or non-native client (a.k.a., communication management resource) associated with the communication device 121 (a.k.a., cellular device). The method may include the mobile communication device 121 or other suitable entity: reporting location information indicating the current location of the communication device 121 to a server component residing in a back office infrastructure 200 of the network. The back office infrastructure may further be connected to other network elements.

In one example, the mobile communication device 121 can be configured to monitor its current location and produce corresponding location information indicating its current location. The communication device 121 (a.k.a., user equipment, mobile communication device, wireless communication device, etc.) can be configured to report back such location information to the infrastructure 200, where the reported information may include parameters such as current location of the communication device 121, usage of the different wireless networks by the communication device 121, device type associated with the communication device 121, etc.

In this example, a server component receiving the reported information associated with the communication device forwards the reported information to the infrastructure 200. In one example, based on policies and predefined criteria, certain reported information received by the infrastructure 200 may trigger provisioning of one or more new eSIM profiles (configuration settings) for downloading and installation on the mobile communication device 121. In other words, as previously discussed, the mobile communication device 121 initially may be configured with the configuration settings 105-1. Certain conditions such as presence of the mobile communication device 121 in the geographical region corresponding to the region of wireless coverage 132-1 or nearby for a certain amount of time may trigger communication of supplemental configuration settings 105-2 to the mobile communication device such that the mobile communication device is able to wirelessly connect to wireless network WN2 and/or wireless network WN3. Thus, after a new configuration setting has been provisioned, such new configuration settings 105-2 (such as one or more profiles) can be requested for retrieval by the communication device 121 or the infrastructure 200 can be configured to transmit the configuration settings 105-2 to the communication device 121 so that is able to connect to other wireless network such as wireless network W2, wireless network WN3, etc.

In one example, the infrastructure 200 can be configured to receive statistics and any suitable information reported by the mobile communication device 121. The infrastructure 200 can be configured to use this information along with the available information associated with the one or more networks to trigger the provisioning of new configuration settings 105-2 (such as including a new eSIM profile or SIM2) for downloading to the mobile communication device 121. In a further example, the infrastructure 200 can be configured to in-turn communicate with the SMDP+, NE, OTA server, Mediation infra to achieve the provisioning of the new configuration settings 105-2, which may or may not be tied to the user 108 operating the mobile communication device 121.

### Details and Explanations

### Back Office Infrastructure 200 Supports:

Location estimation associated with the UE: Location estimation or determination associated with the mobile communication device 121 may be done by location reporting from preloaded apps or other network apps that have been allowed location sharing with or without user consent.

Location estimation—Back office infra: Location estimation can be performed using call records (incoming calls to the mobile communication device 121 or a phone calls from the mobile communication device as captured by the back office systems (infrastructure 200) in case of connectivity to routers and towers are not owned by the second wireless network service provider. As further discussed herein, location mobile communication device 121 may also be estimated based on the UEs connectivity to Wi-Fi™ routers or cellular towers owned by the network operator.

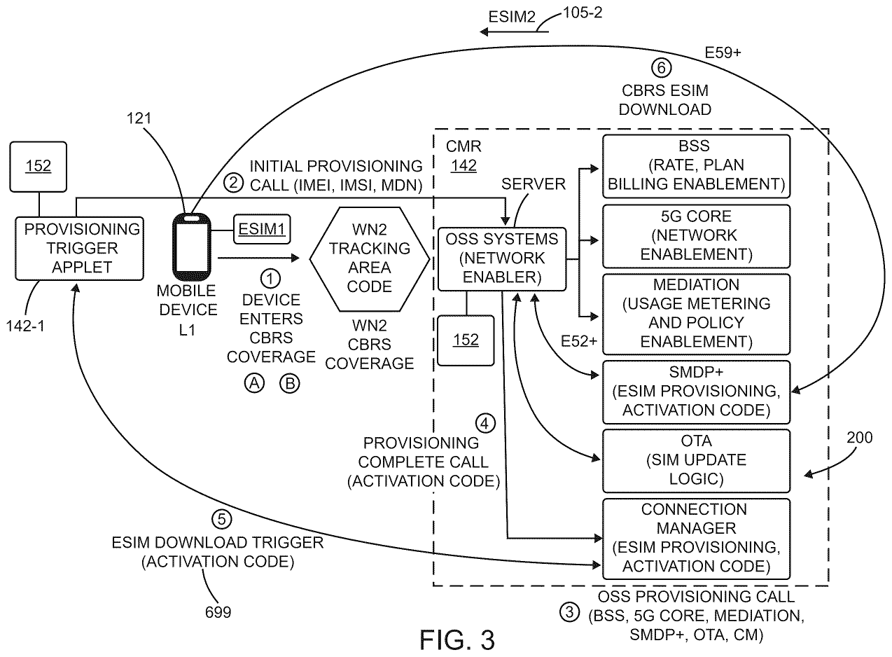

FIG. 3 is an example diagram illustrating a network environment supporting provisioning of configuration settings to a mobile communication device in response to one or more trigger events as discussed herein.

Processing operation #1. The Provisioning Trigger Applet (such as communication management resource 142-1) can be configured to implement the eligible geolocation validation that will provide the trigger to the system 200 and communication management resource 142 for determining whether or not the communication device 121 is in the location that is within the eligible WN2 Tracking Area Code.

Processing operation #2. If the communication device 121 is in a valid location and has passed boundary condition checks, the Provisioning Trigger Applet (a.k.a., communication management resource 142-1) sends an initial provisioning call to the OSS Back Office Systems (communication management resource 142, communication management resource 141, etc.) to initiate the CBRS provisioning for the subscriber and corresponding mobile communication device 121. In one example, the communications in processing operation #2 from the mobile communication device 121 to the infrastructure 200 may include unique identifiers such as IMEI/IMSI/MDN.

Processing operation #3. The OSS Systems in the infrastructure 200 can be configured to trigger additional provisioning to the BSS, 5G Core, Mediation, SMDP+, OTA, and Connection Manager Server systems. The communication management systems as discussed herein can be configured to include error handling mechanisms to recover from provisioning faults.

Processing operation #4. After successful provisioning of the configuration settings 105-2 to the mobile communication device 121, the OSS systems will send a Provisioning Complete Call communication with the previously received eSIM activation code to the Connection Manager Server (CMS) resource in the infrastructure 200. This will allow the CMS resource to prepare the eSIM Download Trigger to the Provisioning Trigger Applet in subsequent processing operation #5.

Processing operation #5. The CMS initiates the eSIM Download Trigger to the Provisioning Trigger Applet, which may include communication of a respective activation code 699 from the communication management resource 142 to the communication management resource 142-1 operated by the mobile communication device 121.

Processing operation #6. The communication device 121 then interacts w the SMDP+ over ES9+ interface in order to download the eSIM (such as SIM2 or configuration settings 105-2 using the activation code 699).

Device triggered eSIM download: Once eSIM has been provisioned and is ready to be downloaded, this can be triggered by periodic check mechanisms implemented within the device provisioning flow. Device could also trigger download based on other device driven triggers such as device reboot etc.

Provisioning Area: A provisioning area (a.k.a., PA) is defined as an area of interest upon entering which the device is expected to trigger provisioning of a subscription.

Triggers—Device Trigger: Device triggered provisioning initiation would be by using an agent on the phone to send out a request/flag to a server component which then triggers the provisioning process. This can be achieved in two ways:
Downloading Provisioning Area details (such as map information 150) on the device: Device looks at the downloaded list of provisioning areas and based on its current location determines whether or not it is within a PA.
Location reporting and determining: Device based on a determined cadence, reports its location to a server entity which then determines based on the received location whether or not the device is within a PA. The server entity then sends back a flag informing the device whether or not within a PA.

Based on a device's presence within a PA either immediately or based on its continued presence within the PA, a provisioning request can be triggered using the NE server component.

Triggers—Network Trigger: These are triggers based on usage, parameters, records, etc., pertaining to a particular device being monitored or processed by the network servers. These can be achieved in the following ways:
Voice records: Based on the voice records collected by the backend servers such as associated with the communication management resource 141, it can be determined which zip codes/locations/Rate centers the user and corresponding communication device 121 are making voice calls from. If the user's location as indicated by the records tracked by the communication management resource 141 is determined to be in an area of interest where the second wireless network service provider happens to provide wireless network services such as any of the regions of wireless coverage 131-1, 132-1, 133-1, etc., the network servers associated with the communication management resource 141 or communication management resource 142 can trigger either immediately or based on the mobile communication device's continued presence within the area of interest, a provisioning process using the NE server component.
Data usage-WiFi: From the WiFi data usage (is used by the communication device 121) records the location of the user and corresponding communication device 121, where the location of the communication device 121 can be approximated by looking up the installed location in case of a managed public hotspot or by using the service address in case of a private Wi-Fi™ AP (135-1). Once the location associated with the wireless access point 135-1 and the corresponding communication device 121 has been approximated, either immediately or based on continued presence or based on configurable usage threshold, a provisioning request to provision the communication device 121 with the configuration settings 105-2 can be triggered using the NE server component or any suitable entity communication with the communication device 121.

Continued Presence: Once an area of interest has been entered, the OSS/mediation servers can be informed to start tracking the subsequent locations of the device. If the device has been observed to spend more than a configurable time threshold over a determined period of tracking within the area of interest, the communication device 121 will be flagged as being in continued presence within the area of interest.

Data usage threshold: Configurable data usage thresholds (WiFi or cellular) can be set to be used either in tandem with or instead of Continued presence to determine a trigger to start provisioning of a subscription.

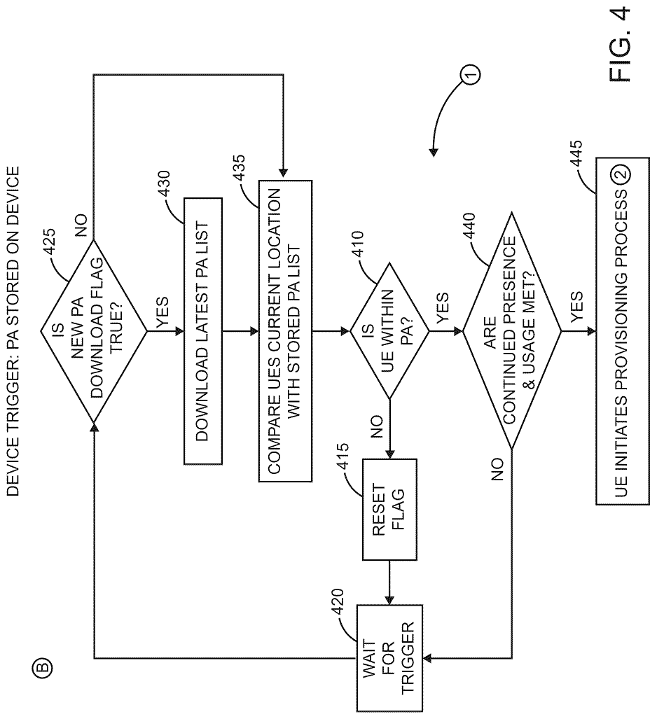

FIG. 4 is an example flow chart illustrating implementation of an algorithm at a mobile communication device supporting dynamic provisioning of wireless connectivity configuration settings based on one or more trigger events as discussed herein.

In this example, the communication device 121 includes the communication management resource 142-1 to monitor operations of the mobile communication device 121 and initiate a provisioning process in which the mobile communication device 121 is provisioned with additional configuration settings 105-2 so that the mobile communication device 121 is able to use wireless services provided by the wireless network WN2.

More specifically, the mobile communication device 121 can be configured with provisioning map information 150 indicating different geographical regions such as regions of wireless coverage supported by the second wireless network WN2 and corresponding wireless base stations 131, 132, etc. Thus, the provisioning map information 150 (a.k.a., provisioning area list) can be configured to indicate the different regions of wireless coverage such as region of wireless coverage 131-1, region of wireless coverage 132-1, region of wireless coverage 133-1, etc.

The communication management resource 142-1 in the communication device 121 monitors its current location such as location L1 at time T1, location L2 at time T2, location L3 at time T3, etc., and so on. At time T1, the communication device 121 may be located outside of the wireless network WN1 as well as the wireless network WN2. In such an instance, in processing operation 410, the communication management resource 142-1 determines that it does not reside in or even near the different regions of wireless coverage as indicated by the provisioning map information 150. In such an instance, processing continues at processing operation 415, where the communication management resource 142-1 resets and event flag managed by the mobile communication device 121.

In processing operation 420, the communication management resource 142-1 waits for a trigger event such as presence of the communication device 121 in or near any of the regions of wireless coverage 131-1, 132-1, 133-1, etc., associated with the second wireless network WN2 for greater than a threshold amount of time.

In processing operation 425, the communication management resource 142-1 determines whether the new provisioning area download flag is set to true, indicating that a new provisioning area list (150) specifying geographical regions where the second wireless network is available to the mobile communication device 121. The communication device 121 may receive this information (150) because the user 108 subscribes to use of the wireless services provided by the second wireless network service provider associated with the second wireless network WN2.

If the new provisioning area download flag is not set to true, meaning that no new provisioning area list is available for download to the communication device 121, processing continues at processing operation 435.

Alternatively, in processing operation 425, in response to the communication management resource 142-1 detecting that the new provisioning area download flag is set to true, the communication management resource 142-1 retrieves the latest provisioning area list (provisioning map information 150) indicating geographical region supporting wireless services associated with the second wireless network service provider.

In processing operation 435, via the provisioning map information 150 (either recently downloaded or previously downloaded), the communication management resource 142-1 compares the current location L1 of the communication device 121 at time T1 to the provisioning map information 150. The communication management resource 140 continues to execute the loop of operations 410, 415, 420, 425, 430, 435, until the mobile communication device 121 is detected as moving into a region of wireless coverage associated with the wireless network WN2.

Assume that the mobile communication device 121 moves to the location L3 at or around time T3.

In processing operation 410, the communication management resource 142-1 determines that the communication device 121 does reside in or even near the different regions of wireless coverage as indicated by the latest received provisioning map information 150 indicating at least geographical regions 131-1, 132-1, 133-1, etc. for example, the communication management resource 142-1 detects that the communication device 121 resides in the region of wireless coverage 132-1 at or around time T3. In such an instance, processing continues at processing operation 440, where the communication management resource 142-1 determines whether the mobile communication device 121 resides in the region of wireless coverage 132-1 for greater than a threshold amount of time. If not, processing by the communication management resource 142-1 continues that processing operation 420. Alternatively, if the communication device 132-1 resides in or near the region of wireless coverage 132-1 for greater than a threshold month time, processing by the communication management resource 142-1 continues at processing operation 445, where the mobile communication device 121 initiates execution of a provisioning process in which the mobile communication device 121 communicates with the communication management resource 142 to receive additional configuration settings 105-2 supporting wireless connectivity of the communication device 121 to the wireless network WN2 or wireless network WN3. Any suitable communication path as discussed herein can be used to support the retrieval of the configuration settings 105-2 by the communication device 121.

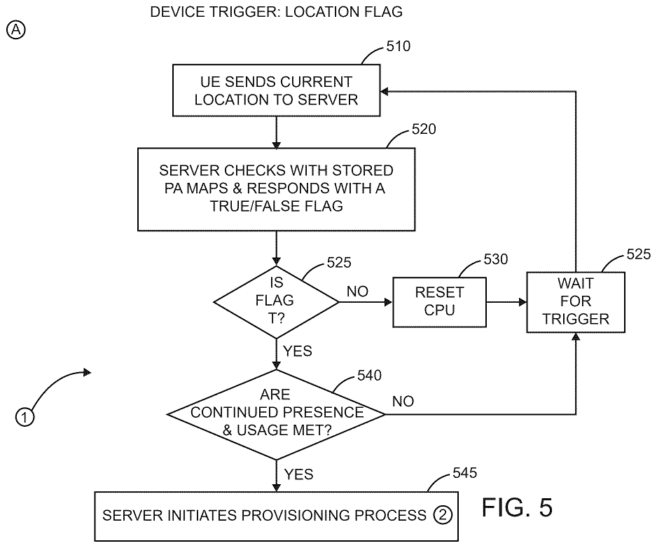

Note that an alternative technique of provisioning the configuration settings 105-2 to the mobile communication device 121 is shown in FIG. 5, where the communication management resource 142 executes corresponding functionality to determine when to initiate download and installation of the configuration settings 105-2 to the mobile communication device 121.

FIG. 5 is an example flow chart illustrating implementation of an algorithm at a server resource supporting dynamic provisioning of wireless connectivity configuration settings based on one or more trigger events as discussed herein.

In this example, the communication management resource 142 monitors events associated with the mobile communication device 121 and dynamically provisions one or more instances of configuration settings supporting wireless services provided by the wireless network WN2 or WN3 to the mobile communication device 121.

More specifically, the communication management resource 142 for other suitable entity maintains provisioning map information 150 indicating the different regions of wireless coverage (such as region of wireless coverage 131-1, region of wireless coverage 132-1, region of wireless coverage 133-1, and so on) supported by the wireless network WN2.

In processing operation 510, the communication management resource 142 receives continuous updates of the current location of the mobile communication device 121 in the network environment 100. At or around time T1, the communication management resource 142 receives notification that the mobile communication device 121 resides outside of the region of wireless coverage 111-1 at location L1.

In processing operation 520, based on the received location information L1, the communication management resource 142 determines whether the mobile communication device resides within any of the regions of wireless coverage (provisioning areas) as indicated by the provisioning map information 150. In response to detecting that the mobile communication device 121 does not reside within any of the regions of wireless coverage 131-1, 132-1, 133-1, etc., as indicated by the provisioning map information 150, the communication management resource 142 sets a respective provisioning flag to false.

In processing operation 525, the communication management resource 142 determines that the provisioning flag is set to false, resulting in further processing in processing operation 530.

In processing operation 530, the communication management resource 142 initiates reset of the continued presence and usage flag associated with the communication device 121 and continues at processing operation 535.

In processing operation 535 and subsequent operations, the communication management resource 142 waits for a respective trigger condition.

Assume that the mobile communication device 121 moves to location L3 at or around time T3. In such an instance, in processing operation 510 at or around time T3, the mobile communication device 121 communicates its current location of L3 to the communication management resource 142. Note that the communication device 121 can be configured to transmit the location information L3 to the communication management resource via the first wireless network WN1 such as including a wireless communication link 127-1 between the communication device 121 and the wireless base station 111.

Further, in processing operation 520, the communication management resource 142 determines that the mobile communication device 121 resides within the region of wireless coverage 132-1 (geographical region). In response to this detected condition, the communication management resource 142 sets the provisioning flag to a true state. In such an instance, in processing operation 525, the communication management resource 142 executes the processing operation 540.

In processing operation 540, the communication management resource 142 monitors a time duration in which the mobile communication device 121 resides in the region of wireless coverage 132-1. In other words, the communication management resource 142 continuously receives feedback from the communication device 121 or other suitable entity indicating whether the communication device 121 continues to reside within the region of wireless coverage 132-1. In this example, the communication device 121 resides at the location L3 for greater than the threshold duration of time as discussed herein.

In processing operation 540, in response to a condition in which the mobile communication device 121 is detected as residing within the region of wireless coverage 132-1 for greater than a threshold time duration, the communication management resource 142 initiates provisioning of new configuration settings 105-2 to the mobile communication device 121.

Provisioning of the new configuration settings 105-2 to the communication device may include the communication management resource 142 or other suitable entity transmitting the configuration settings 105-2 through the remote network 190 and the wireless base station 111 to the communication device 121. The communication device 121 installs the configuration settings 105-2 and executes them to communicate with the wireless base station 132 or any other wireless base station associated with the second wireless network WN2. Accordingly, the new configuration settings 105-2 enable the mobile communication device 121 to use the wireless connectivity services provided by the different wireless base stations 131, 132, 133, etc., associated with the second wireless network WN2.

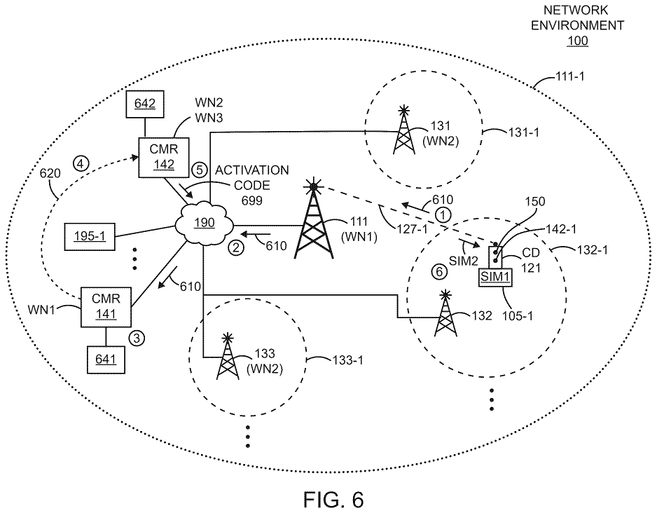

FIG. 6 is an example diagram illustrating tracking of events associated with a communication device wirelessly connected to a first wireless network and provisioning/implementation of wireless connectivity configuration settings associated with a second wireless network as discussed herein.

Further in this example, in processing operation #1 in FIG. 6, the communication device 121 enters the region of wireless coverage 132-1.

In processing operation #2, via the communications 610, the communication device 121 repeatedly communicates its location over the wireless communication link 127-1 through the wireless base station 111 to the communication management resource 141 operated by the first wireless network service provider. As previously discussed, as an alternative to the communication device 121 communicating the location information, instead of transmitting location information, the communication device 121 can be configured to transmit notification (via communications 610) that it has been present in the region of wireless coverage 132-1 for greater than a time duration.

In processing operation #3, the communication management resource 141 associated with the wireless network WN1 stores the notification regarding presence of the mobile communication device 121 in status information 641. In one example, the communication management resource 141 tracks use of the wireless services provided by the wireless network WN1 and corresponding wireless base station 111 and stores it in the status information 641. Based on such information, the communication management resource 142 and corresponding second wireless network service provider is made aware of locations where the mobile communication device 121 uses the first wireless network WN1. The stored status information 641 may also indicate different types of wireless services used by the communication device 121 and corresponding user 108.

In processing operation #4, via communications 620, the communication management resource 142 managed by the second wireless network service provider has access to the status information 641 associated with the first wireless network service provider. The retrieval of the status information, and communication 620, the communication management resource 142 learns that the communication device 121 is currently operated in the region of wireless coverage 132-1 as indicated by the status information 641. In other words, the communication management resource 142 operated by the second wireless network service provider communicates with the communication management resource 141 operated by the first wireless network service provider to learn of wireless services provided by the first wireless network service provider to the communication device 121 as well as where the communication device 121 happens to reside in the network environment 100. The status information 641 may also indicate different times and locations of the mobile communication device 121 using the wireless services provided by the first wireless network, as well as a degree (such as an amount of data, data rate, etc.) to which the mobile communication device 121 uses the respective wireless services.

In processing operation #5, in response to detecting that the communication device 121 resides in the region of wireless coverage 132-1, or at least nearby, or within the region of wireless coverage 111-1, for greater than a threshold amount of time based on monitoring by the first wireless network and corresponding information stored in status information 641, the communication management resource 142 transmits a respective activation code 699 over the network 190 through the wireless base station 111 and the wireless communication link 127-1 to the communication device 121. In other words, the communication management resource 142 associated with the second wireless network service provider determines usage of wireless services provided by the first wireless network service provider and then makes a decision to provision the communication device 121 with configuration settings 105-2 such that the communication device 121 this provided wireless services by the second wireless network WN2 instead of the first wireless network WN1.

In certain instances, the communication management resource 142 may learn from the communication management resource 141 that the communication device 121 is operated within the region of wireless coverage 111-1 for greater than a threshold amount of time, without the communication device 121 even entering the regions of wireless coverage 131-1, 132-1, 133-1, etc. In this case, just the feedback from the communication management resource 141 via communications 620 indicating that the mobile communication device 121 is operated in the region of wireless coverage 111-1 may prompt the second wireless network service provider associated with the communication management resource 142 to initiate installation of the configuration settings 105-2 on the communication device 121 so that the communication device 121 is able to use the second wireless network WN2 corresponding wireless base stations because it is assumed that the communication device 121 will eventually enter one or more regions of wireless coverage provided by the second wireless network. In this latter case, subsequent to installation of the configuration settings 105-2, the communication device 121 can be configured to detect a condition in which the wireless services associated with the second wireless network are available to the communication device 121. The communication device 121 therefore will hand off any connections from the first wireless network to the second wireless network and corresponding wireless base stations for certain types of wireless services such as nonvoice services.

If desired, in furtherance of installing the configuration settings 105-2 and to the communication device 121, the communication management resource 142 can be configured to communicate the activation code 699 to the communication management resource 141, which further communicates the activation code 699 through the wireless network WN1 and corresponding wireless base station 111 to the communication device 121.

In processing operation #5, in response to receiving the activation code 699 for retrieval of configuration settings associated with the wireless network WN2 supporting use of the wireless base station 132, the mobile communication device 121 receives the configuration settings 105-2 from either the communication management resource 142 or the communication management resource 141 and stores the configuration settings 105-2 on the communication device 121.

Accordingly, the communication device 121 is now provisioned with configuration settings 105-2 enabling it to wirelessly connect to the wireless base station 132. As the communication device 121 moves from location to location, the configuration settings associated with use of the second wireless network can be continuously updated so that the mobile communication device 121 is repeatedly and dynamically provisioned with appropriate configuration settings to support wireless connectivity to different wireless base stations of the second wireless network in different geographical regions.

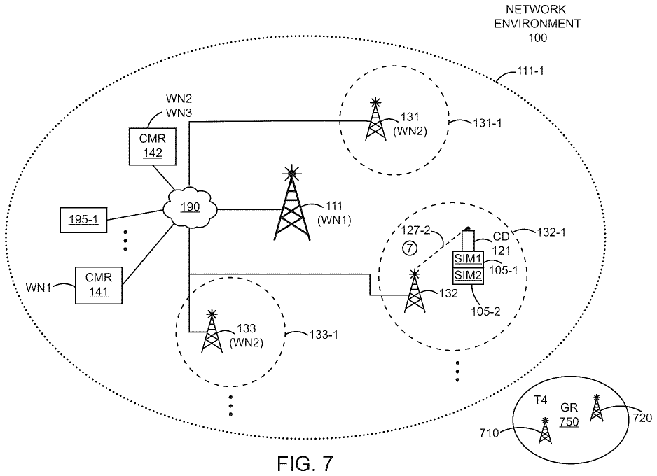

FIG. 7 is an example diagram illustrating implementation of the provisioned wireless connectivity configuration settings by a communication device to access a remote network through the second wireless network as discussed herein.

In one example, the configuration settings 105-2 support nonvoice (data) communications, while the configuration settings 105-1 support either voice communications or nonvoice communications.

The communication device 121 can be configured to select between use of the different wireless networks WN1 and WN2 depending upon what type of data (voice data or nonvoice data) is being retrieved from the different wireless networks for consumption by the communication device 121.

Assume further that the communication device 121 is configured with priority settings indicating that the wireless network WN2 is desired for conveyance of nonvoice data communications between the server 195-1 or other suitable entity and the communication device 121 over the wireless network WN1. In such an instance, in processing operation #7, the communication device 121 establishes the wireless communication link 127-2 with the wireless base station 132. Via a communication path including the wireless communication link 127-2 between the communication device 121 and the server resource 195-1, the mobile communication device 121 transmits the communications to the server resource 195-1 and receives communications from the server resource 195-1.

Accordingly, as discussed herein, the mobile communication device 121 is dynamically provisioned with configuration settings 105-2 in response to detecting a condition in which the communication device 121 moves into a new region of wireless coverage (such as region of wireless coverage 111-1 residing in California) associated with a wireless network to which the user 108 is a subscriber.

At or around time T4, the communication device 121 may be operated in the geographical region 750 such as in New York, which may not support the wireless network WN2. In such an instance, the configuration settings 105-2 can be removed/deleted from the mobile communication device 121.

In a similar manner as previously discussed, presence of the mobile communication device 121 in the geographical region 750 for a particular time duration may result in the communication device 121 being provisioned with further configuration settings enabling the communication device 121 to communicate with any wireless base stations 710 (such as a fourth wireless network) in the geographical region 750 that are operated by the second wireless network service provider. Support provided by the fourth wireless network may require communication of further configuration settings 105-3 supplied to the communication device 121 so that the communication device 121 can communicate with any of the wireless base stations 710 operated in the geographical region 750 by the second wireless network service provider instead of the wireless base station 720 operated by the first wireless network service provider.

Thus, as the communication device 121 moves from location to location, the configuration settings associated with use of the second wireless network and other wireless networks operated by the second wireless network service provider can be continuously updated so that the mobile communication device 121 is repeatedly and dynamically provisioned with appropriate configuration settings to support wireless connectivity to different wireless base stations of the second wireless network in different geographical regions. In other words, when the communication device 121 is located in the vicinity of the multiple geographical regions covered by the region of wireless coverage 111-1, the communication device 121 can be configured with the configuration settings 105-2 to support wireless connectivity with the multiple wireless base stations 131, 132, 133, etc. As the communication device moves to the geographical region 750 at or around time T4, a new set of configuration settings associated with the second wireless network service provider and forth wireless network (wireless base station 710) are communicated to the communication device 121 to support wireless connectivity to the wireless base stations 720 operated by the second wireless network in the geographical region 750.

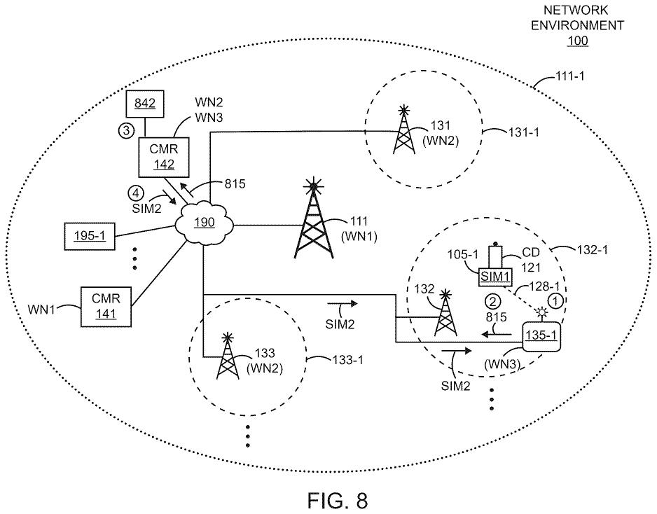

FIG. 8 is an example diagram illustrating tracking of events associated with a communication device wirelessly connected to a third wireless network and provisioning of wireless connectivity configuration settings associated with a second wireless network as discussed herein.

As previously discussed, the second wireless network service provider may operate multiple wireless access points (135-1, etc.) in the network environment 100. In this example, the wireless access point 135-1 operated by the second wireless network service provider is in a vicinity of or within the region of wireless coverage 132-1 and within the region of wireless coverage 111-1.

In processing operation #1, via the wireless communication link 128-1 between the communication device 121 and the wireless access point 135-1, the mobile communication device 121 is operated to access the wireless access point 135-1 and communicate through the wireless access point 135-1 over the remote network 190 to the server resource 195-1.

In such an instance, in processing operation #2, via communications 815 indicating the usage and corresponding wireless connectivity provided by the wireless communication link 128-1, the communication management resource 142 learns and keeps track of the usage of the wireless access point 135-1 by the communication device 121 in or around the geographical region covered by the region of wireless coverage 132-1.

For example, the mobile communication device 121 can be assigned a respective unique network address that is communicated to the communication management resource 142 indicating usage of the wireless services associated with the wireless communication link 128-1 in the wireless access point 135-1. The communication management resource 142 uses the received network address and communications 815 to determine that the communication device 121 is used by a subscriber of wireless services associated with the second wireless network service provider. The communication management resource 142 keeps track of status information 842 indicating that the wireless access point 135-1 used by the mobile communication device 121 resides within the region of wireless coverage 132-1 associated with the wireless base station 132.

In a similar manner as previously discussed, in response to detecting that the communication device 121 resides in the region of wireless coverage 132-1 for greater than a threshold amount of time, the communication management resource 142 transmits a respective activation code 699 over the network 190 through the wireless access point 135-1 and the wireless communication link 128-1 to the communication device 121.

In processing operation #4, in response to receiving the activation code 699 for retrieval of configuration settings 105-2 associated with the wireless network WN2 supporting use of the wireless base station 132 and other wireless base stations, the mobile communication device 121 receives the configuration settings 105-2 and stores them in the communication device 121.

Accordingly, in a similar manner as previously discussed, the communication device 121 is now provisioned with configuration settings 105-2 enabling it to wirelessly connect to the wireless base station 132.

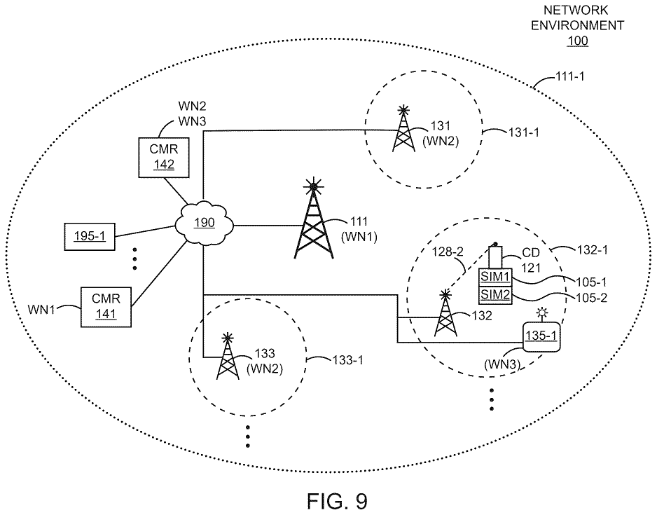

FIG. 9 is an example diagram illustrating implementation of the provisioned wireless connectivity configuration settings by the communication device to access a remote network through the second wireless network as discussed herein.

In one example, the configuration settings 105-2 support nonvoice communications, while the configuration settings 105-1 support either voice communications or nonvoice communications.

The communication device 121 can be configured to select between use of the different wireless networks WN1 and WN2 depending upon what type of data (voice data or nonvoice data) is being retrieved from the different wireless networks for consumption by the communication device 121.

After being configured with the configuration settings 105-2, assume that the mobile communication device 121 travels outside a region of wireless coverage provided by the wireless access point 135-1. In such an instance, the communication device 121 has a choice between using the first wireless network WN1 (via configuration settings 105-1) and the second wireless network WN2 (via configuration settings 105-2).

Assume further that the communication device 121 is configured with priority settings indicating that the wireless network WN2 is desired for conveyance of nonvoice data communications between the server 195-1 and the communication device 121 instead of over the wireless network WN1. In such an instance, in processing operation #7, the communication device 121 establishes the wireless communication link 128-2 with the wireless base station 132 instead of wireless base station 111. Via a communication path including the wireless communication link 127-2 between the communication device 121 and the server resource 195-1, the mobile communication device 121 transmits the communications to the server resource 195-1 and receives communications from the server resource 195-1.

Accordingly, as discussed herein, the mobile communication device 121 is dynamically provisioned with configuration settings 105-2 in response to detecting a condition in which the communication device 121 moves into a new region of wireless coverage (such as region of wireless coverage 111-1 residing in California) associated with a wireless network to which the user 108 is a subscriber.

At or around time T4, the communication device 121 may be operated in the geographical region 750 such as in New York, which may not support the wireless network WN2. In such an instance, the configuration settings 105-2 can be removed/deleted from the mobile communication device 121.

In a similar manner as previously discussed, presence of the mobile communication device 121 in the geographical region 750 for a particular time duration may result in the communication device 121 being provisioned with further configuration settings enabling the communication device 121 to communicate with any wireless base stations in the geographical region 750 that are operated by the second wireless network service provider. This may require communication of further configuration settings 105-3 supplied to the communication device 121 so that the communication device 121 can communicate with any of the wireless base stations 710 operated in the geographical region 750 by the second wireless network service provider instead of the wireless base stations 720 operated by the first wireless network service provider.

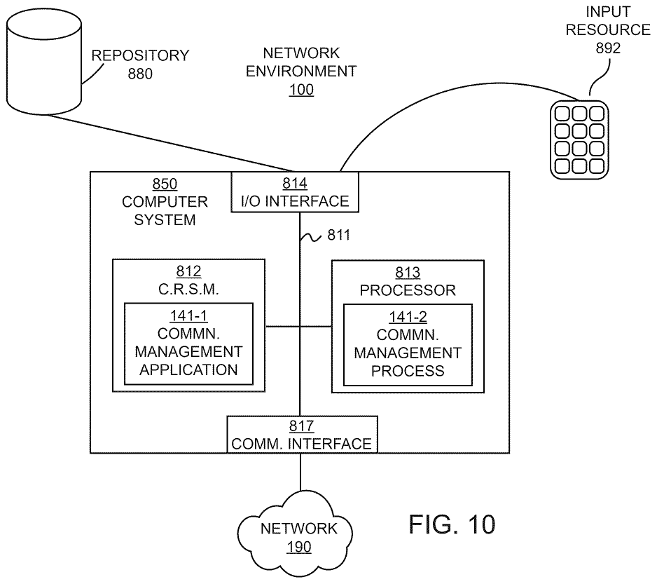

FIG. 10 is an example block diagram of a computer system for implementing any of the operations as previously discussed according to examples herein.

Any of the resources (mobile communication device 121, communication management resource 141, communication management resource 142, communication management resource 141-1, communication management resource 142-1, etc.) as discussed herein can be configured to include computer processor hardware and/or corresponding executable instructions to carry out the different operations as discussed herein via computer system 1050.

As shown, computer system 1050 of the present example includes an interconnect 1011 coupling computer readable storage media 1012 such as a non-transitory type of media or, more generally, computer readable hardware which can be any suitable type of hardware storage medium in which digital information can be stored and retrieved, a processor 1013 (computer processor hardware), I/O interface 1014, and a communications interface 1017.

I/O interface(s) 1014 supports connectivity to repository 1080 and input resource 1092.

Computer readable storage medium 1012 (such as computer readable hardware or other suitable entity) can be a hardware storage device or resource such as memory, optical storage, hard drive, floppy disk, etc. In one example, the computer readable storage medium 1012 stores instructions and/or data. Computer readable storage medium 1012 can be a non-transitory storage medium or include non-transitory storage hardware.

As shown, computer readable storage media 1012 can be encoded with communication management application 140-1 (e.g., including instructions) to carry out any of the operations as discussed herein.

During operation of one example, processor 1013 accesses computer readable storage media 1012 via the use of interconnect 1011 in order to launch, run, execute, interpret or otherwise perform the instructions in management application 140-1 stored on computer readable storage medium 1012. Execution of the management application 140-1 produces the management process 140-2 to carry out any of the operations and/or processes as discussed herein.

Those skilled in the art will understand that the computer system 1050 can include other processes and/or software and hardware components, such as an operating system that controls allocation and use of hardware resources to execute the management application 140-1.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1050 may reside at any location or can be included in any suitable resource in any network environment to implement functionality as discussed herein. In one example, the control system 1050 can include or be implemented in virtualization environments such as the cloud.

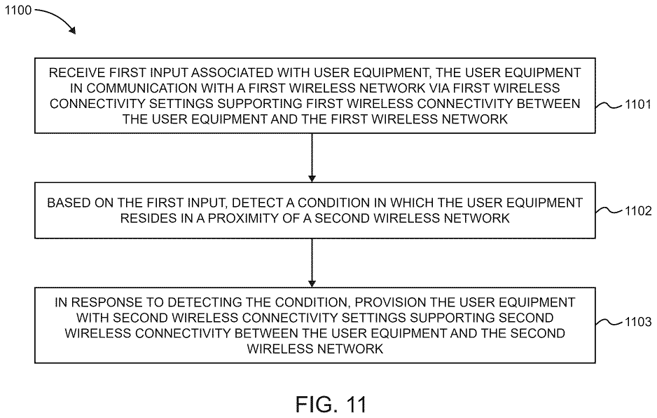

Functionality supported by the different resources will now be discussed via flowchart in FIG. 11. Note that the steps in the flowcharts below can be executed in any suitable order.

FIG. 11 is a flowchart 1100 illustrating an example method according to examples. Note that flowchart 1100 overlaps/captures general concepts as discussed herein.

In processing operation 1110, a communication management resource receives first input associated with user equipment (communication device 121), where the user equipment is configured with first configuration settings 105-1 to communicate with a first wireless network WN1.

In processing operation 1120, based on the first input such as indicating presence of the user equipment in near proximity to the second wireless network for greater than a time duration threshold level, the communication management resource detects a condition in which the user equipment resides in a proximity of a second wireless network WN2 or WN3.

In processing operation 1130, in response to detecting the condition, the communication management resource configures the user equipment with second configuration settings 105-2 to communicate with the second wireless network WN2 or WN3.

Note again that techniques herein are well suited to facilitate distribution of configuration settings in a network environment. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
receiving first input associated with user equipment, the user equipment configured with first configuration settings to communicate with a first wireless network;
based on the first input, detecting a condition in which the user equipment resides in a region of wireless coverage provided by a second wireless network; and
in response to detecting the condition, configuring the user equipment with second configuration settings to communicate with the second wireless network.

2. The method as in claim 1, wherein the first configuration settings support first wireless connectivity and conveyance of corresponding first communications between the user equipment and the first wireless network prior to detecting the condition.

3. The method as in claim 2, wherein configuring the user equipment to communicate with the second wireless network includes transmitting the second configuration settings over the first wireless network to the user equipment.

4. The method as in claim 1, wherein the first input indicates a location of the user equipment in a network environment.

5. The method as in claim 4, wherein the detected condition is detected presence of the user equipment in the region of wireless coverage provided by the second wireless network, the detected presence determined based on the user equipment using the first wireless network.

6. The method as in claim 1, wherein configuring the user equipment with the second configuration settings includes:
transmitting the second configuration settings over the first wireless network to the user equipment.

7. The method as in claim 6, wherein the first wireless connectivity between the user equipment and the first wireless network supports both voice communications and non-voice communication; and
wherein the second wireless connectivity between the user equipment and the second wireless network supports only non-voice communications.

8. The method as in claim 1, wherein the first input includes location information indicating at least one location in which the user equipment is operated to wirelessly connect to a third wireless network.

9. The method as in claim 8, wherein the user equipment is configured to communicate with the second wireless network via the second configuration settings in response to detecting presence of the user equipment in a particular geographical region for greater than a threshold level of time.

10. The method as in claim 1, wherein detecting the condition further includes detecting that the user equipment resides within the region of wireless coverage provided by the second wireless network for greater than a threshold time duration.

11. A system comprising:
communication management hardware operative to:
receive first input associated with user equipment, the user equipment configured with first configuration settings to communicate with a first wireless network;
based on the first input, detect a condition in which the user equipment resides in a region of wireless coverage provided by a second wireless network; and
in response to detecting the condition, configure the user equipment with second configuration settings to communicate with the second wireless network.

12. The system as in claim 11, wherein the first configuration settings support first wireless connectivity and conveyance of corresponding first communications between the user equipment and the first wireless network prior to detecting the condition.

13. The system as in claim 12, wherein the communication management hardware is further operative to:
transmit the second configuration settings over the first wireless network to the user equipment.

14. The system as in claim 11, wherein the first input indicates a location of the user equipment in a network environment.

15. The system as in claim 14, wherein the detected condition is detected presence of the user equipment in the region of wireless coverage provided by the second wireless network, the detected presence determined based on the user equipment using the first wireless network.

16. The system as in claim 11, wherein the communication management hardware is further operative to: transmit the second configuration settings over the first wireless network to the user equipment.

17. The system as in claim 16, wherein the first wireless connectivity between the user equipment and the first wireless network supports both voice communications and non-voice communication; and
wherein the second wireless connectivity between the user equipment and the second wireless network supports only non-voice communications.

18. The system as in claim 11, wherein the first input includes location information indicating at least one location in which the user equipment is operated to wirelessly connect to a third wireless network.

19. The system as in claim 18, wherein the user equipment is configured to communicate with the second wireless network via the second configuration settings in response to detecting presence of the user equipment in a particular geographical region for greater than a threshold level of time.

20. The system as in claim 11, wherein the communication management hardware is further operative to:
detect that the user equipment resides within the region of wireless coverage provided by the second wireless network for greater than a threshold time duration.

21. Computer-readable storage hardware having instructions stored thereon, the instructions, when carried out by computer processor hardware, cause the computer processor hardware to:
receive first input associated with user equipment, the user equipment configured with first configuration settings to communicate with a first wireless network;
based on the first input, detect a condition in which the user equipment resides in a region of wireless coverage provided by a second wireless network; and
in response to detecting the condition, configure the user equipment with second configuration settings to communicate with the second wireless network.
